(19) United States
(12) Patent Application Publication
(10) Pub. No.: US 2011/0157641 A1
(43) Pub. Date: Jun. 30, 2011

(54) IMAGE FORMING APPARATUS AND IMAGE FORMING SYSTEM

(75) Inventor: Hiroshi FURUKAWA, Tokyo (JP)

(73) Assignee: KONICA MINOLTA BUSINESS TECHNOLOGIES, INC., Tokyo (JP)

(21) Appl. No.: 12/971,899

(22) Filed: Dec. 17, 2010

(30) Foreign Application Priority Data
Dec. 24, 2009 (JP) 2009-293253

(51) Int. Cl. G06F 3/12

(52) U.S. Cl. 358/1.15

(57) ABSTRACT

In an image forming system configured with image forming apparatuses and an administration server connected with the image forming apparatuses thereof via Internet, the image forming unit, mounted at the image forming section in a detachable manner, stores unit information which includes identification data and information of times of use. An operation section creates unit replacing permission information to permit the image forming unit to be dismounted from the image forming section. A control section receives the unit replacing permission information and reads out the unit information. The communication section transmits the unit information to the administration server. Whereby, the administration server can recognize the image forming unit dismounted from the image forming section and the times of used of the image forming unit just before dismounting, therefore the burden of the service engineer can be reduced.

This application is based on Japanese Patent Application No. 2009-293253 filed on Dec. 24, 2009, in Japanese Patent Office, the entire content of which is hereby incorporated by reference.

### TECHNICAL FIELD

The present invention relates to an image forming apparatus and an image forming system connected with an administration server to control an image forming section to form an image from a remote location.

### BACKGROUND OF THE INVENTION

Generally, in an image forming apparatus such as a printer, copying machine and multifunction peripheral, a toner image is formed by a developing device on an image carrier such as photoconductive drum, the image is transferred onto an intermediate transfer belt, and the image is transferred onto a sheet from the intermediate transfer belt so as to form the image on the sheet. Remaining toner adhering on the photoconductive drum after transferring the toner image is removed from an outer circumferential surface of the photoconductive drum via a cleaning mechanism.

The photoconductive drum, developing device and cleaning device are installed in a housing so called image forming unit. The image forming unit is installed in a detachable manner in the image forming apparatus main body. For example, the image forming unit is detached at the time of maintenance of the image forming apparatus.

In Patent Document 1: Unexamined Japanese Patent Application Publication No. 2003-330695, there is disclosed an image forming apparatus which places an order of a part to be replaced or an expendable item. According to the image forming apparatus, unique information of the present image forming apparatus is stored and when a part related to image forming malfunctions, a part reached to a predetermined operating life or consumption of an expendable item related to image forming exceeds a predetermined threshold, the image forming apparatus warns to replace the part or expendable item. Then ordering details of the part warned to be replaced or the expandable item is inputted, and the image forming apparatus transmits the inputted order detail and the unique information of the image forming apparatus to a central control device to control the present image forming apparatus.

Also, Patent Document 2: Unexamined Japanese Patent Application Publication No. 2004-334752, discloses an information processing apparatus to administrate a part usage history of an image forming apparatus. According to the information processing apparatus, a count value of a part installed on the image forming apparatus is obtained, a magnitude relation of the obtained count value is judged and if the count value is judged being decreased, the count value of the part before replacing which is obtained the last time is a usage record of the part before replacing.
Patent Document 1: Unexamined Japanese Patent Application Publication No. 2003-330695,
Patent Document 2: Unexamined Japanese Patent Application Publication No. 2004-334752,

Incidentally, the image forming apparatus of Patent document 1 can place the order for the expendable part or the part warned about replacing, however there is a problem that the central administration apparatus can not recognize statuses of use of the expendable part or said part. Also, the information processing apparatus disclosed in Patent Document 2 can administrate the operation life of the part by recovering a correct count value, even if a user cancels the count value for the status of use of the part (operating life), however there is a problem that it cannot administrate the operation life of the part dismounted from the image forming apparatus when the part is replaced.

Incidentally, the part dismounted is not always one arrived to an end of the operation life which is sometimes replaced by a user for image quality improvement. In the above case, a service engineer is dispatched to a site where the image forming apparatus is installed and investigates the status of use of the dismounted part, thereafter the engineer come back again to the site to bring a new part and replace it, which is a large burden for the service engineer.

### SUMMARY

The present invention has one aspect to solve the above problems and an object of the present invention is to provide an image forming apparatus and an image forming system which recognize the status of use of the part by confirming an image forming unit dismounted from the image forming apparatus and reduce the burden of the service engineer (number of times of visit the site).

To achieve the above object, the image forming apparatus and system reflecting one aspect of the present invention has the following:
Structure 1. An image forming apparatus connected with an administration server to administrate an image forming section to form an image from a remote location, including: an image forming unit disposed at the image forming section in a detachable manner, having a memory to memorize unit information which includes identification data and information of times of use; an operation section to create unit replacing permission information to permit dismounting the image forming unit from the image forming section; a control section to receive the unit replacing information created by the operation section, and read out the unit information stored in the memory based on the unit replacing permission information having been received; and a communication section to transmit the unit information read out by the control section to the administration server.
Structure 2. An image forming system having the image forming apparatus and the administration section of Structure 1.

In the image forming apparatus of Structure 1 and the image forming system of Structure 2, the image forming section is connected with the administration server which controls the image forming section to form the image from the remote location. The image forming unit is provided with the memory to store the unit information which includes the identification data and the information of times of use and is mounted at the image forming section in the detachable manner. The operation section creates the unit replacing permission information to permit the image forming unit to be dismounted from the image forming section before the image forming unit is dismounted form the image forming section. The control section receives the unit replacing permission information created by the operation section, and reads out the unit information stored in the memory of the image forming unit based on the unit replacing permission information received. Then the communication section transmits the unit information read out by the control section to the administration server.

Whereby, the administration server can recognizes the image forming unit dismounted from the image forming section via the identification data by receiving the unit information transmitted from the communication section of the image forming apparatus and recognizes the times of use of the image forming unit just before dismounting via the information of times of use.

### BRIEF DESCRIPTION OF THE DRAWINGS

FIG. 1 is a block diagram showing an exemplary configuration of an image forming system related to a first embodiment.

FIG. 2 is a block diagram indicating an exemplary control system of an image forming apparatus 1A.

FIG. 3 is an explanatory diagram indicating an exemplary configuration of unit information stored in a memory 41b.

FIG. 4 is an explanatory diagram indicating an exemplary configuration of unit information stored in a memory 42b.

FIG. 5 is an explanatory diagram indicating an exemplary configuration of unit information stored in a memory 43b.

FIG. 6 is an explanatory diagram indicating an exemplary configuration of unit information stored in a memory 44b.

FIG. 7 is a flow chart indicating an exemplary operation of an image forming apparatus A1.

FIG. 8 is a block diagram showing an exemplary configuration of a control system of an image forming apparatus 3 related to a second embodiment.

FIGS. 9A, 9B, and 9C are explanatory diagrams showing exemplary configurations of unit information stored in a memory 80a.

FIG. 10 is a flow chart showing an exemplary operation of an image forming apparatus 3.

### DETAILED DESCRIPTION OF PREFERRED EMBODIMENTS

An image forming system and an image forming apparatus related to the present invention will be described with reference to the drawings.

### First Embodiment

### [Exemplary Configuration of Image Forming System 100]

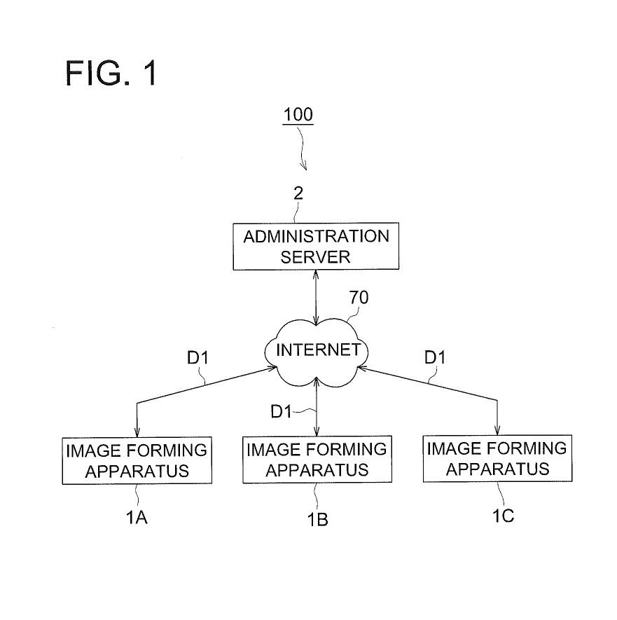

FIG. 1 is a block diagram showing an exemplary configuration of an image forming system 100 related to a first embodiment. As FIG. 1 shows, the image forming system 100 is configured with image forming apparatuses 1A, 1B, and 1C, and an administration server 2. The image forming apparatuses 1A, 1B, and 1C, are, for example, a printer, a copying machine and a multifunction peripheral.

The image forming apparatuses 1A, 1B, and 1C are connected with the administration server 2 via Internet 70 representing an exemplary network. The image forming apparatuses 1A, 1B, and 1C are provided with the image forming units which are mounted in a detachable manner at the image forming sections to form the image. The image forming unit is provided with a memory to store unit information D1 including identification data and information of times of use. The image forming apparatuses 1A, 1B, and 1C read out the unit information D1 from the memory provided in the image forming unit and send it to the administration server 2 when the image forming unit is detached form the image forming section.

The administration server 2 administrates the image forming sections and image forming units of the image forming apparatuses 1A, 1B, and 1C from a remote location. The administration server 2 becomes capable of recognizing the image forming unit detached form the image forming section via the identification data by receiving the unit information D1 transmitted form the image forming apparatuses 1A, 1B, and 1C, and capable of recognizing the times of use of a replaceable part installed in the detached image forming unit via the information of the times of use.

As above, according to the image forming system 100 related to the present embodiment, since the administration sever 2 can recognize the times of use of the image forming unit just before and after being detached from the image forming section, it is not necessary that the service engineer visits the site of the image forming apparatus to inspect the times of use of each part of the image forming unit detached from the image forming apparatus, and after that the service engineer comes back to the site of the image forming apparatus again with a new part of the image forming unit to replace it. Thus burden of the service engineer (the times of visiting the site) can be reduced.

Incidentally, in the present embodiment, while the image forming system configured with three image forming apparatuses 1A, 1B and 1C are described, the image forming system can be configured with two or less, or four or more image forming apparatuses.

### [Exemplary Configuration of Image Forming Apparatus 1A]

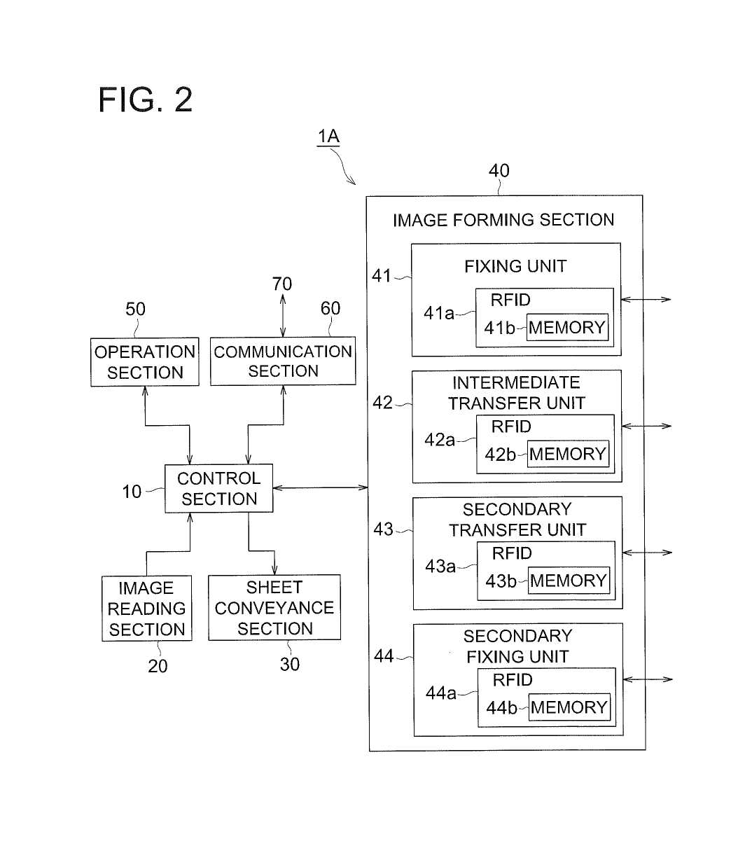

Next, an exemplary configuration using the image forming apparatus 1A shown in FIG. 1 representing a printer will be described. FIG. 2 is a block diagram showing an exemplary configuration of a control system of the image forming apparatus 1A. As FIG. 2 shows, the image forming apparatus 1A is configured with a control section 10, an image reading section 20, a sheet conveyance section 30, an image forming section 40, an operation section 50 and a communication section 60.

To the control section 10, the image reading section 20, the sheet conveyance section 30, the image forming section 40, the operation section 50 and the communication section 60 are connected respectively. The control section 10 controls the image reading section 20, the sheet conveyance section 30, the image forming section 40, the operation section 50 and the communication section 60.

The image reading section 20 reads an image via a CCD representing an example of an imaging element to create image information, and outputs the created image information to the image forming section 40. The sheet conveyance section 30 conveys sheets from a tray in which the sheets are stored one by one to the image forming section 40.

The image forming section 40 receives the image information outputted form the image reading section 20 and forms a toner image based on the received image information. Then the image forming section 40 fixes the created toner image on the sheet conveyed from the sheet conveyance section 30.

The image forming section 40 is provided with a fixing unit 41 representing an example of the image forming unit, an intermediate transfer unit 42, a secondary transfer unit 43 and a secondary fixing unit 44 in the detachable manners.

The fixing unit 41 heats the sheet on which the toner image is formed with a heater, and fixes the toner image onto the sheet by nipping the sheet by fixing rollers. The fixing unit 41 is provided with an electric wave ID tag (hereinafter called RFID 41a) which reads and writes information from an outside via short distance wireless communication.

RFID41a is provided with a nonvolatile memory 41b which stores the unit information. The unit information includes identification data of the fixing unit 41, a part name provided in the fixing unit 41, times of use (count) of the part, and an operation life (upper limit of the count) of the part. RFID41a can read the unit information via a RIFD reader and can reset (make the count number zero) the count number of the unit information via a RIFD writer.

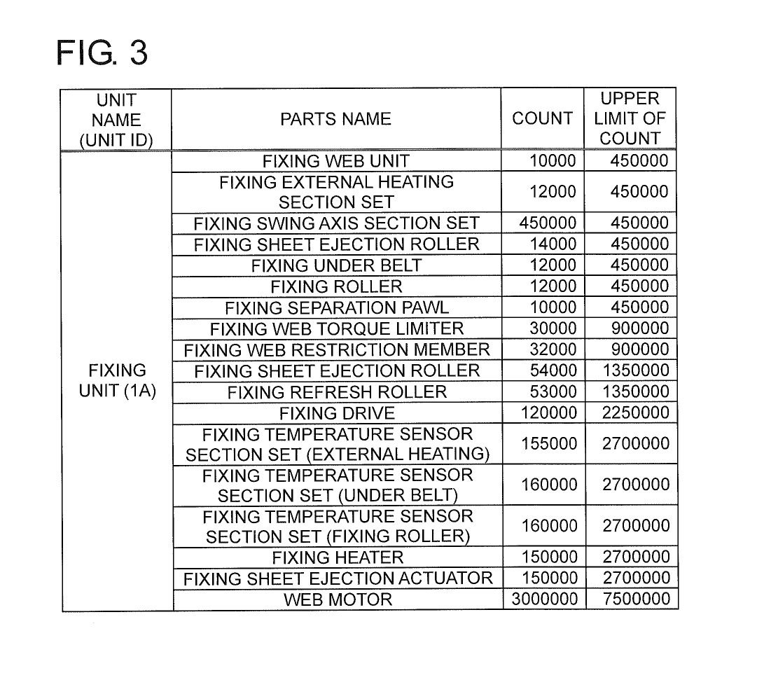

FIG. 3 is an explanatory diagram indicating an exemplary configuration of the unit information stored in the memory 41b. As FIG. 3 shows, the memory 41b stores a unit name, a unit ID (identification data), a part name, a count number (information of number of times of use) and an upper limit of the count number. For example, the memory 41b stores the unit name as “fixing unit”, and the unit ID as “1A”. Also, for example, the memory 41b stores the parts name as “fixing web unit” and the count number thereof as “10000” and the upper limit of the count number as “450000”. Namely, it is indicated that the fixing web unit provided in the fixing unit 41 can be operated 450000 times in a brand-new state, and since it has been operated 10000 times so far, it can be operated 440000 timed afterward. Also, the memory 41b stores a part name as “fixing swing axis section set”, the count number thereof as “450000” and the upper limit of the count number as “450000”. Namely, the fixing swing axis section set provided in the fixing unit 41 can be operated 450000 times at a brand-new state, and since it has been operated 450000, it has arrived at an operation life. Since the rest of the parts shown in FIG. 3 can be understood in the same manner, descriptions are omitted.

The intermediate transfer unit 42 forms toner images of yellow (Y), magenta(M), cyan (M) and black (K) colors on the photoconductive drum respectively and transfers the formed toner images onto the intermediate transfer belt. The intermediate transfer unit 42 is provided with a RFID42a in which the nonvolatile memory 42b to store the unit information is implanted. The unit information includes identification data of the intermediate transfer unit 42, a part name of a part provided in the intermediate transfer unit 42, times the part was used (count number) and an operation life of the part (upper limit of count number). The RFID42a can read the unit information via the RFID reader and can reset (make the count number zero) the count number of the unit information via the RFID writer.

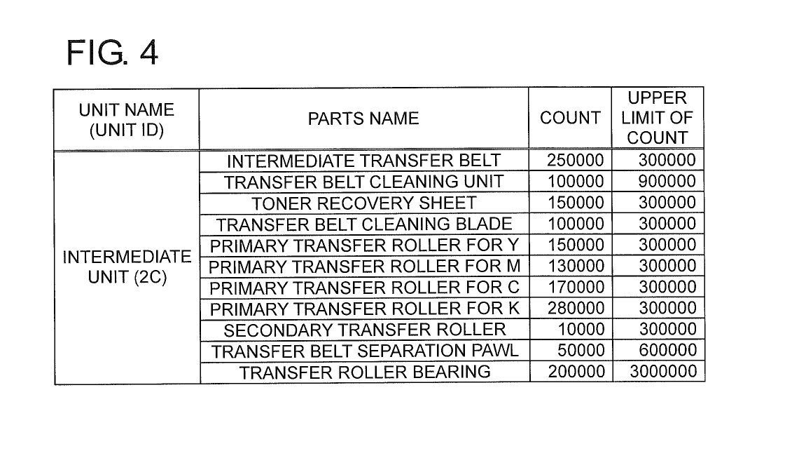

FIG. 4 is an explanatory diagram indicating an exemplary configuration of the unit information stored in the memory 42b. As FIG. 4 shows, the memory 42b stores a unit name, a unit ID (identification data), a plurality of part names, a count number (information of times of use) and an upper limit of the count number. For example, the memory 41b stores the unit name as “intermediate transfer unit”, and the unit ID as “2C”. Also, for example, the memory 42b stores the part name as “intermediate transfer belt”, and the count number thereof as “250000” and the upper limit of the count number as “300000”. Namely, it is indicated that the intermediate transfer belt provided in the intermediate transfer unit 42 can be operated 300000 times in a brand-new state, and it has been operated 250000 times so far, thus it can be operated 50000 times afterward. Since the rest of the parts shown in FIG. 4 can be understood in the same manners, descriptions are omitted.

The secondary transfer unit 43 transfers the toner image formed on the intermediate transfer belt via intermediate transfer unit 42 onto the sheet via a secondary transfer belt. The secondary transfer unit 43 is provided with the RFID43a in which a nonvolatile memory 43b to store the input information is implanted. The unit information includes identification data of the secondary transfer unit 43, a part name of a part provided in the secondary transfer unit 43, the times the part was used (count number) and an operation life of the part (the upper limit of the count number). The RFID43a can read the unit information via the RFID reader and can reset (make the count number zero) the count number of the unit information via the RFID writer.

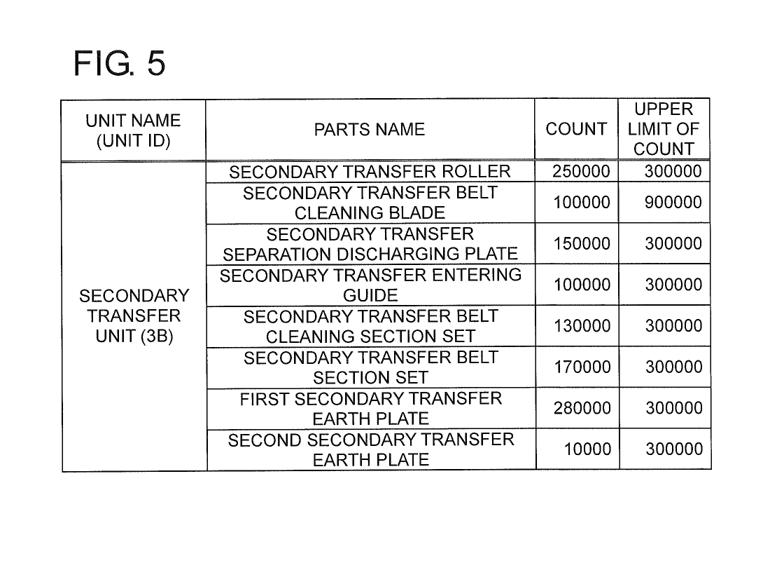

FIG. 5 is an explanatory diagram indicating an exemplary configuration of unit information stored in a memory 43b. As FIG. 5 shows the memory 43b stores a unit name, a unit ID (identification data), a plurality of part names, a count number (information of number of times of use) and an upper limit of the count number. For example, the memory 43b stores the unit name as “secondary transfer unit”, and the unit ID as “3B”. Also, for example, the memory 43b stores the part name as “secondary transfer belt”, the count number thereof as “250000” and the upper limit of the count number as “300000”. Namely, it is indicated that the intermediate transfer belt provided in the secondary transfer unit 43 can be operated 300000 times in a brand-new state, and it has been operated 250000 times so far, thus it can be operated 50000 times afterward. Since the rest of the parts shown in FIG. 4 can be understood in the same manners, descriptions are omitted.

A secondary fixing unit 44 heats the sheet on which the toner image is fixed by a fixing unit 41 via a secondary fixing lamp to melt the toner and contacts the sheet with the secondary fixing belt having a smooth surface so as to fix the toner. Whereby, a toner image having a smooth and high grazed surface can be formed on the sheet. The fixing unit 44 is provided with the RFID44a in which the nonvolatile memory 44b to store the unit information is implanted. The unit information includes identification data of the secondary transfer unit 44, a part name of a part provided in the secondary transfer unit 44, times the part was used (count number) and an operation life of the part (upper limit of count number). The RFID44a can read the unit information via the RFID reader and can reset (make the count number zero) the count number of the unit information via the RFID writer.

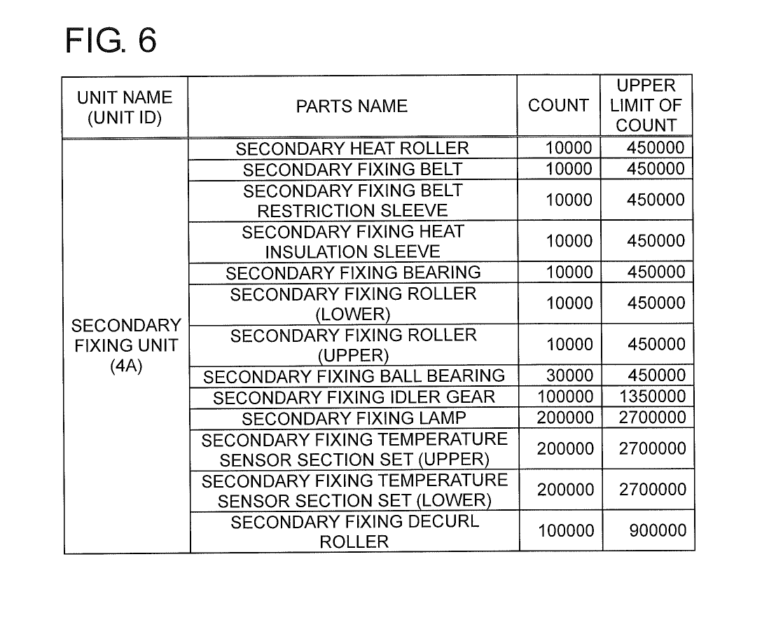

FIG. 6 is an explanatory diagram indicating an exemplary configuration of the unit information stored in a memory 44b. As FIG. 6 shows the memory 44b stores a unit name, unit ID (identification data), a plurality of part names, a count number (information of images of use) and an upper limit of the count number. For example, the memory 44b stores the unit name as “secondary transfer unit”, and the unit ID as “4A”. Also, for example, the memory 44b stores the part name as “secondary fixing heat roller”, the count number thereof as “10000” and the upper limit of the count number as “450000”. Namely, it is indicated that the secondary fixing heat roller provided in the secondary fixing unit 44 can be operated 450000 times in a brand-new state, and it has been operated 10000 times so far, thus it can be operated 440000 times afterward. Since the rest of the parts shown in FIG. 6 can be understood in the same manners, descriptions are omitted.

Returning to FIG. 2, the operation section 50 is configured with a liquid crystal display utilizing a touch panel method and buttons. By operating the operation section 50 by a user, operation information is outputted to the control section 10. The operation information includes an instruction of start printing, sizes and number of sheets to be printed, and changing a mode to replace the image forming unit.

In case the fixing unit 41, the intermediate transfer unit 42, the secondary transfer unit 43 or the secondary fixing unit 44 is dismounted from the image forming section 40, for example, when the operation mode is switched to an image forming unit replacing mode via the operation section 50, the liquid crystal display shows a guidance for a dismounting procedure of each image forming unit. In accordance with the guidance, the user carries out dismounting of the unit. Also, the operation section 50 creates and outputs unit replacing information representing exemplary unit replacing permission information.

The control section 10 increments the times of use one by one when the part of the fixing unit 41, the part of the intermediate transfer unit 42, the part of the secondary transfer unit 43 or the part of the secondary fixing unit 44 operates. Then, when the unit replacing permission information outputted from the operation section 50 is received, the unit information shown by FIG. 3 to FIG. 6 stored in the memories 41b, 42b, 43b and 44b are read out. Thereafter, the control section 10 outputs the unit information read out to the communication section 60.

The communication section 60 connected with Internet 70 transmits the unit information outputted from the control section 10 to the administration server 2 via the Internet 70. Also, the communication section 60 receives an updating program of the image forming apparatus 1A transmitted form the administration server 2 and outputs it to the control section 10.

The administration server 2 receives the unit information sent from the communication section 60. For example, in case the fixing unit 41 having the unit ID of “1A” is dismounted from the image forming section 40 and the administration server 2 receives the unit information shown by FIG. 3, the administration server 2 becomes capable of recognizing that the fixing unit 41 having the unit ID of “1A” is dismounted form the image forming section 40, and capable of confirming the times of use of the part of the dismounted fixing unit 41 via the information of the times of use. For example, as FIG. 3 shows, it can be confirmed that the count number of the fixing swing axis section set provided in the fixing unit 41 has arrived at the upper limit of the count number and the operation life has ended.

### [Exemplary Operation of Image Forming Apparatus 1A]

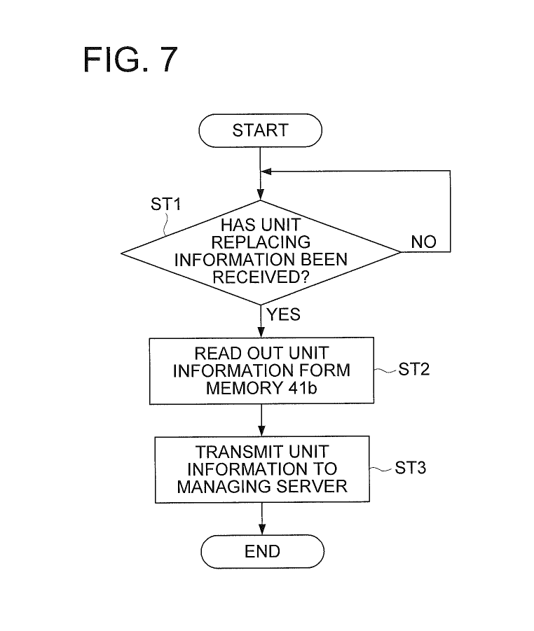

Next, an exemplary operation of the image forming apparatus 1A will be described. FIG. 7 is a flow chart indicating the exemplary operation of the image forming apparatus 1A. The image forming unit 40 is provided with the fixing unit 41 which is supposed to be dismounted afterward. As FIG. 7 shows, in Step ST1, the control section 10 judges again whether or not the unit replacing permission information outputted from the operation section 50 is received.

For example, a screen related to a mode in which the image forming unit is dismounted is displayed on the liquid crystal display provided in the operation section 50 by operating the operation section 50 by the user. In the screen, unit dismounting methods to dismount the fixing unit 41, the intermediate transfer unit 42, the secondary transfer unit 43 or the secondary fixing unit 44 are displayed. By operating the operation section 50, in accordance with the unit dismounting method displayed on the liquid crystal display, unit replacing information is created by the operation section 50, and the unit replacing information created is outputted to the control section 10.

When the unit replacing information is received, the control section 10 recognizes that the fixing unit will be dismounted from now on and proceeds with Step ST2. Also, the control section 10 judges whether or not the unit replacing information has been received in Step ST1, if the unit replacing information is not received.

In Step 2, the control section 10 reads out unit information from the memory 41b provided in the fixing unit 41. The unit information is, for example, one shown in FIG. 3, including a unit name of the fixing unit 41, a unit ID, a part name, a count number and an upper limit of the count number.

In Step 3, the control unit 10 outputs the unit information read out from the memory 41b to the communication section 60. Then the communication section 60 transmits the unit information outputted from the control section 10 to the administration server 2 via Internet 70.

The administration server 2 receives the unit information transmitted from the communication section 60. Whereby, the administration server 2 recognizes that the fixing unit 41 is dismounted from the image forming section 40 and the times the part was used provided in the dismounted fixing unit 41.

For example, the service engineer confirms the unit information transmitted to the administration server 2, and as FIG. 3 shows, he recognizes that the count number reaches to the upper limit of the “fixing swing axis section set”. Then the service engineer visits the site where the image forming apparatus 1A is installed along with a new fixing swing axis section set so as to replace the fixing swing axis section set of the fixing unit 41 dismounted, whose count number reaches to the upper limit, with the new fixing swing axis section set brought. Whereby, the visiting time of the service engineer to the installing site is reduced to one time.

As above, according to the image forming apparatus 1A related to the present embodiment, since the image forming unit dismounted from the image forming section 40 and the time of use just before dismounting the image forming unit can be confirmed by the administration server 2, it is not necessary that the service engineer visits the site where the image forming apparatus is installed to check the times of used of the image forming unit dismounted from the image forming section, after that the service engineer visits the site again along with the new image forming unit to replace it. Therefore, the burden of the service engineer can be reduced (the times of visiting the installing site).

Incidentally, in the present embodiment, while the image forming apparatus 1A is described, the image forming apparatuses 1B and 1C also have the same configurations and the same functions.

Also, in the present embodiment, while a case that the fixing unit 41, the intermediate transfer unit 42, the secondary transfer unit 43 or the secondary fixing unit 44 is dismounted from the image forming section 40 is described, in case that the fixing unit 41, the intermediate transfer unit 42, the secondary transfer unit 43 or the secondary fixing unit 44 is mounted at the image forming section 40, the control section 10 also reads out the unit information stored in the memories 41b, 42b, 43b and 44b, and outputs the unit information read out to the administration server 2 via the communication section 60.

Whereby, the administration server 2 can recognize the image forming unit mounted at the image forming section 40 by receiving the unit information via the identification data, and recognize the times of use of the mounted image forming unit via the information of the times of use. Further, the state of use of the image forming unit can be recognized from the time of mounting and the time for replacing the image forming unit can be predicted. As a result, the image forming units for replacements can be prepared before the operation life ends for the respective users who have image forming units having different limits of use (operation life) respectively and the image forming apparatuses 1A can be operated without interruption.

### Second Embodiment

In the present embodiment, an image forming apparatus 3 in which a memory 80a is provided in the control section 10 of the image forming apparatus 1A will be described. Since elements having the same names or the same symbols have the some functions, descriptions thereof are omitted.

### [Exemplary Configuration of Image Forming Apparatus 3]

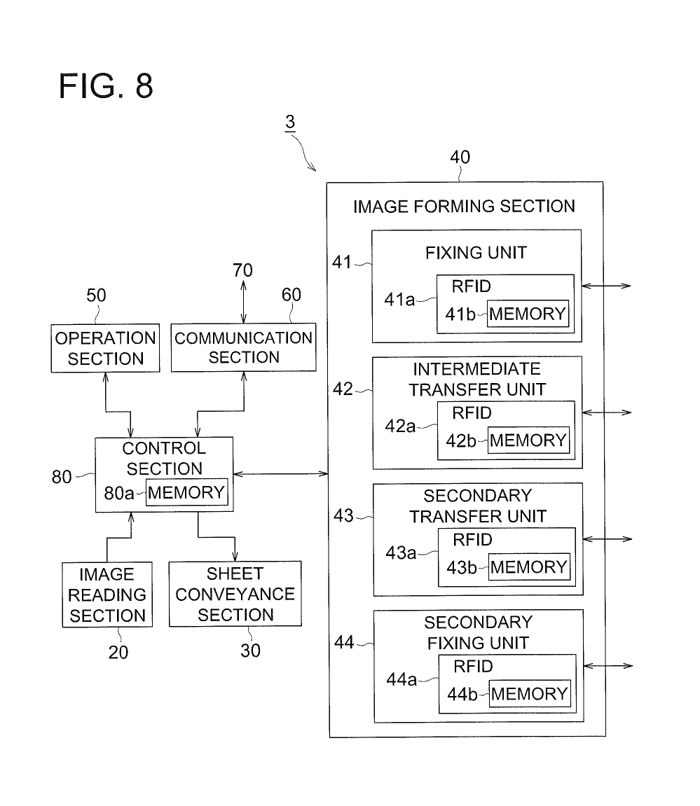

FIG. 8 is a block diagram showing an exemplary configuration of a control system of an image forming apparatus 3 related to a second embodiment. As FIG. 8 shows, the image forming apparatus 3 is configured with a control section 80, an image reading section 20, a sheet conveyance section 30, an image forming section 40, an operation section 50 and a communication section 60.

To the control section 80, the image reading section 20, the sheet conveyance section 30, the image forming section 40, the operation section 50 and the communication section 60. The control section 80 controls the image reading section 20, the sheet conveyance section 30, the image forming section 40, the operation section 50 and the communication section 60.

The control section 80 is provided with a nonvolatile memory 80a. The memory 80a stores a unit ID representing an example of the unit information stored in memories 41b, 42b, 43b and 44b, a part name, a count number of the part and an upper limit of the count number. The memory 80a further stores unit ID of the image forming unit currently mounted at the image forming section 40, unit ID about the image forming unit before replacing and the count number of the part.

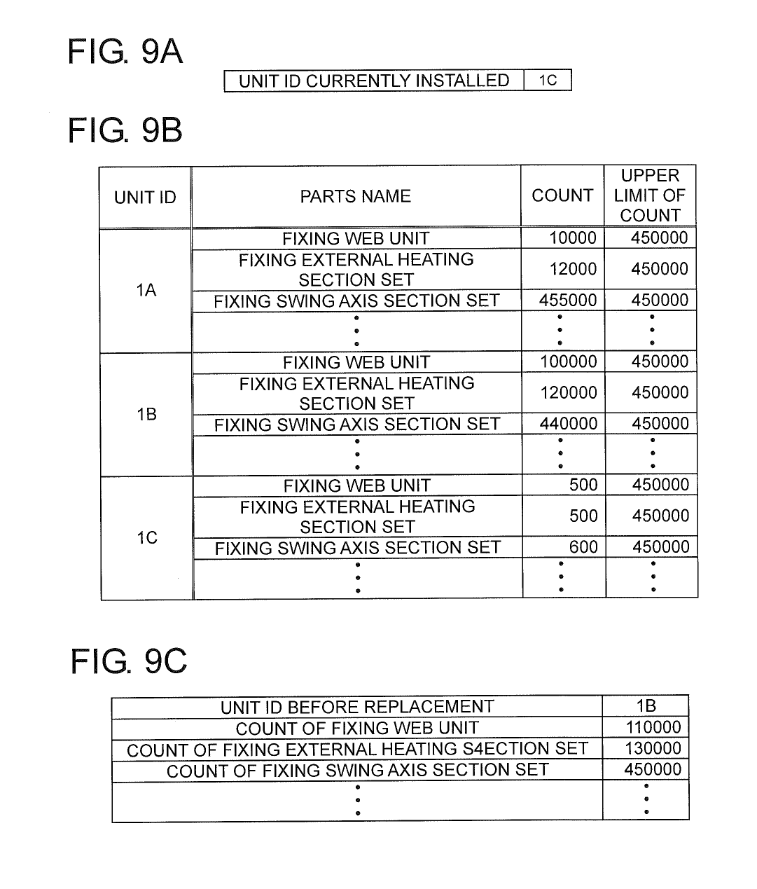

FIGS. 9A, 9B, and 9C are explanatory diagrams showing exemplary configurations of the unit information stored in the memory 80a. FIGS. 9A, 9B, and 9C are premised on that the unit information about the fixing unit 41 is stored. Naturally, the unit information about the intermediate transfer unit 42, the secondary transfer unit 43 and the secondary fixing unit 44 are stored in the memory 80a, however the descriptions thereof are omitted.

As FIG. 9A shows, the memory 80a stores the unit ID of the fixing unit 41 currently mounted. For example, in FIG. 9, said unit ID is stored as “1C” in the memory 80a.

As FIG. 9B shows, the memory 80a stores unit ID of the image forming unit having been mounted and currently mounted, a part name, a count number and an upper limit of the count number. For example, in FIG. 9B, the memory 80a stores the part names, the count number and the upper limit of the count number thereof for the three fixing units 41 having unit IDs of “1A”, “1B” and “1C”. For example, the unit information stored in the memory 80a shows that the fixing unit 41 having the unit ID of “1A” operated the fixing web unit 10000 times, wherein the fixing web unit is capable of being operated 450000 times. Also, the unit information stored in the memory 80a shows that the fixing swing axis section set is used exceeding the upper limit of the count number by 5000 times, since the count number of the fixing swing axis section set of the fixing unit 41 having the unit ID of “1A” is 455000 times.

As FIG. 9C shows, the memory 80a stores the unit ID, the part name and the count number of the fixing unit 41 previously mounted before the current fixing unit 41 is mounted (namely, the fixing unit before replacing). For example, in FIG. 9(C), the memory 80a stores the unit ID before replacing as “1B”, the count number of the fixing web unit as “110000”, the count number of the fixing external heating section set as “130000” and the count number of the fixing swing axis section set as “450000”.

As FIGS. 9A, 9B, and 9C shows, the service engineer recognizes via the administration server 2 that the fixing unit 41 has been replaced in an order of the unit ID of “1A”, “1B” and “1C” since the unit ID currently mounted is “1C” and the unit ID before replacing is “1B”. Also, since the count numbers of the fixing swing axis section sets having the unit IDs of “1A” and “1B” have reached to the upper limit of the count number, the service engineer recognizes that two fixing swing axis section sets have to be brought to the site where the image forming apparatus is installed.

Returning to FIG. 8, the control section 80 increments the times of use one by one and store in the memory 80a shown in FIGS. 9A, 9B, and 9C as the unit information at the time of image forming when the part of the fixing unit 41, the part of the intermediate transfer unit 42, the part of the secondary transfer unit 43 or the part of the secondary fixing unit 44 operates. The timing of storing is a timing where the fixing unit 41, the intermediate transfer unit 42, the secondary transfer unit 43 or the secondary fixing unit 44 is dismounted from the image forming section 40 or the fixing unit 41, the intermediate transfer unit 42, the secondary transfer unit 43 or the secondary fixing unit 44 is mounted at the image forming section 40.

When the unit replacement permission information outputted from the operation section 50 is received, the control section 80 reads out the unit information stored in the memory 80a and copies in the memories 41b, 42b, 43b and 44b and also outputs to the communication section 60. After that, the control section 80 controls the communication section 60 so as to transmit the outputted unit information to the control server 2.

Whereby, by receiving the unit information shown by FIGS. 9A, 9B, and 9C transmitted from the communication section 60, the administration server 2 can administrate the fixing unit 41 whose unit ID is “1C” mounted at the image forming section 40 as well as a plurality of the fixing units 41 whose unit IDs are “1A” and “1B” dismounted from the image forming section 40

### [Exemplary Operation of the Image Forming Apparatus 3]

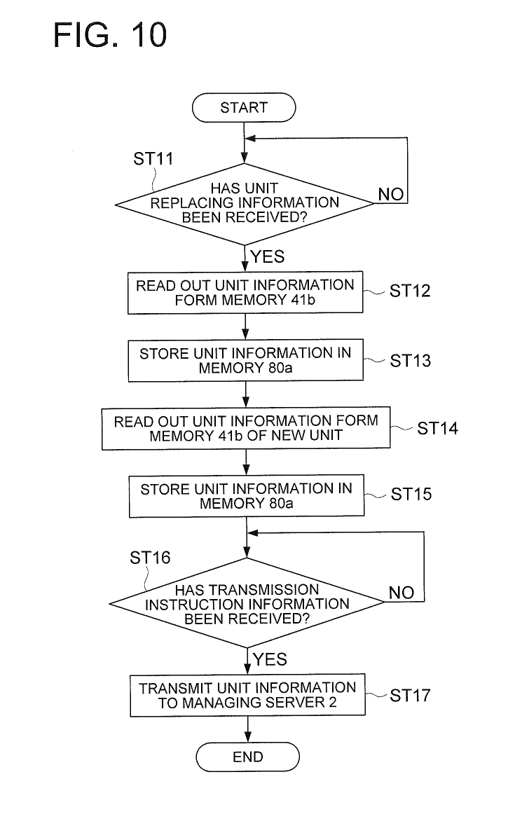

Next, an exemplary operation of the image forming apparatus 3 will be described. FIG. 10 is a flow chart showing an exemplary operation of an image forming apparatus 3. The image forming section 40 is provided with the fixing unit 41 having the unit ID of “1B” and the fixing unit 41 is supposed to be dismounted from the image forming section 40 thereof As FIG. 10 shows, Step ST11 and Step ST12 are equivalent to the Step ST1 and Step ST2 in the aforesaid first embodiment described in FIG. 7 in which the control section 10 is replaced with the control section 80, therefore descriptions are omitted.

In Step ST13 the control section 80 stores the unit information read out form the memory 41b and stores in the memory 80a provided in the control section 80.

In Step ST14, when a new fixing unit 41 having the unit ID of “1C” is mounted at the image forming section 40, the control section 80 reads out the unit information of the fixing unit from the memory 41b. Incidentally, the image forming section 40 is provided with a mounting sensor. When the fixing unit 41 is mounted at the image forming section 40, the mounting sensor outputs mounting completion information to indicate the fixing unit 40 is mounted. Then the control section 80 detects that the fixing unit 41 is mounted at the image forming section 40 by receiving the mounting completion information outputted form the mounting sensor.

In Step ST15, the control section 80 stores the unit information read out from the memory 41b in the memory 80a in the same manner as in Step 13.

In Step 16, the control section 80 detects whether or not transmission instruction information is outputted to the administration server 2 from the operation section 50. The transmission instruction information is created in the operation section 50 and outputted to the control section 80 at a discretional timing of the user. When the control section 80 detects output of the transmission instruction information, Step ST17 is executed. If the control section 80 does not detect the transmission instruction information, the operation waits so as to receive the unit replacing permission information outputted form the operation section 50.

In Step ST17, the control section 80 outputs the unit information to be stores in the memory 80a to the communication section 60. Then the communication section 60 transmits the unit information outputted from the control section 80 to the administration server 2 via Internet 70.

The administration server 2 receives the unit information transmitted by the communication section 60. Whereby the administration server 2 recognizes that the fixing unit 41 having the unit ID of “1B” is dismounted form the image forming section 40 and the times of use of the part provided in the dismounted fixing unit 41 via the unit information received. Further the administration server 2 recognizes that the fixing unit 41 having the unit ID of “1C” is mounted at the image forming section 40 and the times of use of the part provided in the mounted fixing unit 41 via the received unit information.

As above, according to the image forming apparatus 3 related to the present embodiment, every time the fixing unit 41 is dismounted from the image forming section 40 or every time the fixing unit 41 is mounted at the image forming section 40, the unit information of the fixing unit 41 is stored in the memory 80a, and the unit information stored is transmitted by the communication section 60 to the administration server 2. Whereby, the administration server 2 can administrates the fixing unit 41 mounted at the image forming section 40 as well as the plurality of the fixing units 41 dismounted form the image forming section 40.

Incidentally, in the present embodiment, while the timing, at which the unit information stored in the memory 80a is transmitted to the administration server 2, is described as the timing at which the unit information was instructed to be transmitted by operating the operation section 50 via the user, the timing can be set discretionary. For example, the timing can be every time a predetermined time is elapsed, a timing when the image forming unit is dismounted from the image forming section 40, a timing when the image forming unit is mounted at the image forming section 40, a timing when the control section 80 requests the administration server 2 for the unit information or a timing when the power of the image forming apparatus is turned on or off.

According to the image forming apparatus and the image forming system of the present embodiment, the administration server can recognize the image forming unit dismounted form the image forming section and the times the image forming unit was used just before dismounting. Whereby, unlike the conventional image forming apparatus, it is not necessary that the service engineer visits the site where the image forming apparatus is installed to check the times of use of the image forming unit dismounted from the image forming section, then the service engineer visit the site where the image forming apparatus is installed again to bring the new image forming unit for replacing. Therefore the burden (times of visiting the site) of the service engineer is reduced.

What is claimed is:

1. An image forming apparatus connected with an administration server to administrate an image forming section to form an image from a remote location, comprising:
an image forming unit disposed at the image forming section in a detachable manner, having a memory to memorize unit information which includes identification data and information of times of use;
an operation section to create unit replacing permission information to permit dismounting of the image forming unit from the image forming section;
a control section to receive the unit replacing information created by the operation section, and read out the unit information stored in the memory based on the unit replacing permission information having been received; and
a communication section to transmit the unit information read out by the control section to the administration server.

2. The image forming apparatus of claim 1, wherein the control section reads out the unit information stored in the memory in case the image forming unit is mounted at the image forming section and the communication section transmits the unit information read out by the control section to the administration server.

3. The image forming apparatus of claim 1, wherein a memory section is connected with the control section, the memory section stores the unit information read out by the control section and the communication section transmits the unit information stored in the memory section to the administration server.

4. An image forming system configured with an image forming apparatus having an image forming section to form an image and an administration server connected with the image forming apparatus via a network to administrate the image forming section from a remote location, wherein, the image forming apparatus comprises:
an image forming unit disposed at the image forming section in a detachable manner, having a memory to memorize unit information which includes identification data and information of times of use;
an operation section to create unit replacing permission information to permit dismounting of the image forming unit from the image forming section;
a control section to receive the unit replacing information created by the operation section, and read out the unit information stored in the memory based on the unit replacing permission information having been received; and
a communication section to transmit the unit information read out by the control section to the administration server.

5. The image forming system of claim 4, wherein the control section reads out the unit information stored in the memory in case the image forming unit is mounted at the image forming section and the communication section transmits the unit information read out by the control section to the administration server.

6. The image forming system of claim 4, wherein a memory section is connected with the control section, the memory section stores the unit information read out by the control section and the communication section transmits the unit information stored in the memory section to the administration server.
